(19) United States
(12) Patent Application Publication
(10) Pub. No.: US 2024/0403643 A1
(43) Pub. Date: Dec. 5, 2024

(54) COMPUTER-IMPLEMENTED TECHNOLOGIES FOR TRAINING AND COMPRESSING A DEEP NEURAL NETWORK

(71) Applicant: Microsoft Technology Licensing, LLC, Redmond, WA (US)

(72) Inventors: Tianyi CHEN, Kenmore, WA (US); Tianyu DING, Kirkland, WA (US); Luming LIANG, Redmond, WA (US); Ilya Dmitriyevich ZHARKOV, Sammamish, WA (US)

(21) Appl. No.: 18/325,379

(22) Filed: May 30, 2023

(51) Int. Cl. G06N 3/082; G06N 3/0464

(52) U.S. Cl. CPC G06N 3/082; G06N 3/0464

(57) ABSTRACT

Technologies described herein relate to training and compressing a computer-implemented model. To that end, an untrained computer-implemented model is obtained, where the untrained computer-implemented model is to be trained and compressed. The untrained computer-implemented model includes an operator that comprises a structure. Further, training data is obtained, where the training data is to be employed to train the computer-implemented model. Upon receipt of a request from a user, the untrained computer-implemented model is trained and compressed based upon the training data. The untrained computer-implemented model is trained and compressed without further input from the user, such that a trained and compressed computer-implemented model is generated. The trained and compressed model does not include the structure.

### BACKGROUND

Relatively complex computer-implemented models, such as (large-scale) deep neural networks (DNNs), have been successfully used to perform various tasks, such as text generation, text summarization, object classification, amongst numerous other tasks. These computer-implemented models, however, tend to consume a relatively large amount of computer-readable memory, thereby rendering use of such models in resource-constrained environments (such as mobile phones) impractical or, in some cases, impossible.

Research has been conducted with respect to techniques for compressing DNNs; however, conventional approaches for compressing DNNs are computationally expensive and require significant engineering efforts and expertise. For example, the technique of weight pruning has been utilized to reduce size of a DNN, where weight pruning involves removing redundant structures in the DNN. Weight pruning has become popular, as a DNN that has been subject to weight pruning requires fewer floating point operations (FLOPs) when executed when compared to the uncompressed DNN and is smaller in size when compared to the uncompressed DNN.

Conventional weight pruning techniques, however, are associated with several deficiencies. For example, conventional weight pruning techniques require a significant amount of engineering effort and expertise in order to apply such techniques to any particular DNN. Further, conventional weight pruning techniques include training the DNN multiple times during compression, including pre-training the DNN, intermediate training (where such training is employed to learn weights associated with the DNN and identify redundancy in the DNN), and then fine-tuning the DNN subsequent to redundant structures being removed from the DNN. Additionally, conventional weight pruning techniques are designed for specific DNN architectures and use cases, and thus must be significantly modified to be applicable to other architectures and use cases.

### SUMMARY

The following is a brief summary of subject matter that is described in greater detail herein. This summary is not intended to be limiting as to the scope of the claims.

Described herein are various technologies pertaining to training and compressing a computer-implemented model (such as a DNN) without pre-training or fine-tuning the model. The technologies described herein provide an end to end model compression framework, requiring relatively little engineering effort or expertise to both train and compress a computer-implemented model.

With more specificity, upon receipt of a computer-implemented DNN, minimal removal structures in the DNN are identified, where a minimal removal structure refers to a structure of the DNN that, when removed, does not cause the DNN to become invalid (e.g., the DNN generates valid output despite the structure being removed from the DNN). Trainable variables of the minimal removable structures are then partitioned into what is referred to herein as “zero invariant groups” (ZIGs). An optimization function is subsequently employed to solve a structured sparsity optimization problem, where the optimization function solves the structured sparsity optimization problem based upon the ZIGs. The model is trained during the solving of the problem referenced above. Based upon an identified solution to the structured sparsity optimization problem, a compressed DNN is constructed, where the compressed DNN fails to include a structure that is included in the (original) DNN. The compressed DNN is able to perform inference operations faster than the trained (uncompressed) DNN, and further consumes less computer-readable storage than the trained (uncompressed) DNN. Moreover, as will be described in greater detail herein, the compressed DNN does not need to be fine-tuned, thereby conserving computational resources when compared to conventional technologies for compressing computer-implemented DNNs.

In operation, a computing system obtains a DNN that is to be trained and compressed. The DNN includes an operator, where the operator includes structure. Example operators include an addition operator, a multiplication operator, a convolution operator, a pooling operator, an activation operator, etc. An example structure can include a filter matrix, a bias vector, a scalar, etc. Further, an operator can be associated with a trainable parameter (e.g., a variable with a value that is to be learned during training). Accordingly, output of some types of operators (such as the convolution operator) can be based upon input to the operator and a value of the trainable parameter.

Training data that is to be employed to train the DNN is additionally obtained. A request is then received from a user to simultaneously train and compress the DNN, where the DNN is to be trained based upon the training data. In response to receiving the request, based upon the training data, and without further input from the user, the DNN is trained and compressed to generate a trained and compressed DNN. The trained and compressed DNN, as referenced above, does not include the structure that is included in the (untrained) DNN. Moreover, fine tuning is not performed on the trained and compressed DNN prior to the trained and compressed DNN being deployed in a computing system.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that is configured to train and compress a computer-implemented deep neural network (DNN).

FIG. 2 is a schematic that depicts operations involved in connection with training and compressing a computer-implemented DNN.

FIG. 3 is a flow diagram illustrating a methodology for training and compressing a computer-implemented DNN.

FIG. 4 is a schematic of trace graph of a DNN.

FIG. 5 is a flow diagram illustrating a methodology for identifying zero invariant groups (ZIGs) in a DNN.

FIG. 6 is a schematic that illustrates vertices of a trace graph of a DNN being assigned categories.

FIG. 7 is a schematic that illustrates sets of connected components identified based upon categories assigned to vertices in a trace graph of a DNN.

FIG. 8 is a schematic that illustrates expansion of sets of connected components based upon categories assigned to vertices in a trace graph of a DNN.

FIG. 9 is a schematic that illustrates ZIGs in a DNN.

FIG. 10 is a flow diagram illustrating a methodology for training a DNN based upon identified redundant ZIGs in a DNN.

FIG. 11 is a plot that identifies a search direction to be used when identifying redundant ZIGs in the DNN.

FIG. 12 is a schematic that illustrates compression of a DNN through removal of structures in the DNN.

FIG. 13 is a flow diagram that illustrates a methodology for compressing a DNN.

FIG. 14 depicts a computing system.

### DETAILED DESCRIPTION

Various technologies pertaining to training and compressing a computer-implemented model, such as a deep neural network (DNN), are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices

Described herein are various technologies pertaining to training and compressing a computer-implemented model, such as a DNN, without requiring pre-training of the model or fine-tuning of the model after the model is compressed. Examples set forth herein pertain to DNNs (which include convolutional neural networks (CNNs), recurrent neural networks (RNNs), amongst others); however, it is understood that the technologies described herein relate to training and compressing any suitable (relatively complex) computer-implemented model. With more particularity, an untrained DNN is received, and training data that is to be used to train the DNN is obtained. Minimal removal structures of a particular class (referred to herein as a zero invariant group (ZIG)) in the DNN are identified, where the DNN remains valid when a ZIG having parameter values of zero is removed from the DNN (e.g., the DNN can generate valid output despite the ZIG being removed from the DNN). Thereafter, the DNN is trained and redundant ZIGs in the DNN are identified (through use of a Dual Half-Space Projected Gradient (DHSPG) algorithm). Thereafter, redundant ZIGs and ZIGs that depend on such redundant ZIGs are removed, resulting in a trained and compressed DNN. The technologies described herein allow for a DNN to be trained and compressed without requiring fine-tuning of the DNN. The trained and compressed DNN consumes less computer-readable storage in comparison with the DNN when trained using conventional techniques (conventional DNN), and the trained and compressed DNN generates outputs using fewer processing resources in comparison to the conventional DNN, due to a reduction of floating point operations (FLOPs) performed by a processor when executing the trained and compressed DNN when compared to the number of FLOPs performed by the processor when executing the conventional DNN.

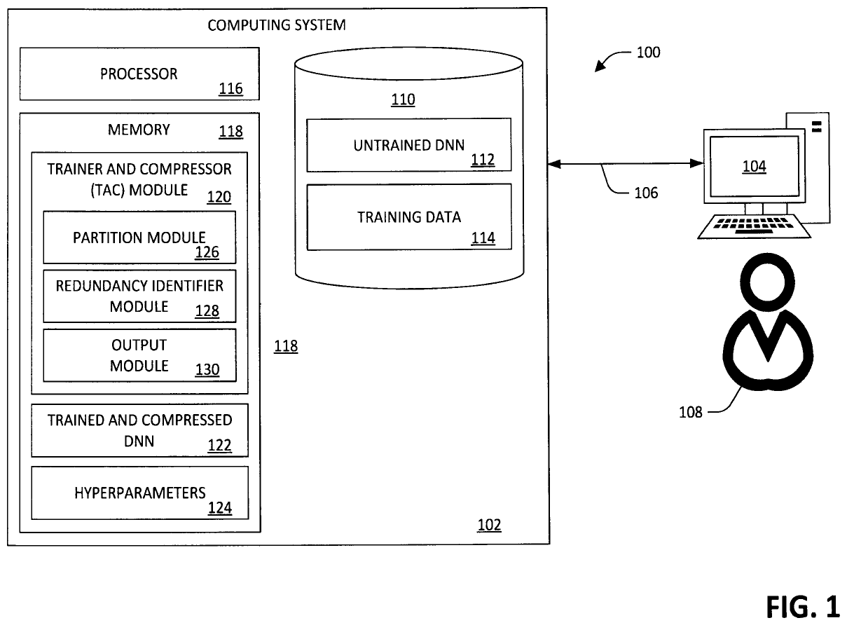

With reference now to FIG. 1, a computing system 100 that trains and compresses a computer-implemented model (such as a DNN) is illustrated. The computing system 100 is in communication with a client computing device 104 by way of a network connection 106. The client computing device 104 is operated by a user 108 who identifies a DNN that is to be trained and compressed; the user 108 can further identify training data that is to be employed to train the DNN.

The computing system 100 includes a data store 110, where the data store 110 includes an untrained DNN 112 and training data 114 for training the untrained DNN 112. The training data 114 includes labeled training data. In an example, the training data 114 includes images and labels that identify: 1) objects that are included in the images; and 2) locations of the objects in the images. Hence, when the untrained DNN 112 is trained based upon such training data 114, the trained DNN can receive an image and identify objects in such image (and locations of the objects in the image). There are numerous tasks for which the untrained DNN 112 can be trained, and object recognition in images is one example of the many different tasks that can be performed through use of a DNN.

The computing system 100 further includes a processor 116 and memory 118, where the memory 118 includes instructions that are executed by the processor 116. With more specificity, the memory 118 includes a trainer and compressor (TAC) module 120. The TAC module 120, in general, receives the untrained DNN 112 and the training data 114 and generates a trained and compressed DNN 122 based upon the untrained DNN 112 and the training data 114. Additionally, the TAC module 120 trains the untrained DNN 112 based upon a set of hyperparameters 124. The set of hyperparameters 124 can include learning rate, batch size, momentum, and/or other suitable hyperparameters that are used when training a DNN. The hyperparameters 124 can be defined by the user 108, identified automatically by way of a suitable hyperparameter identification algorithm, etc.

The TAC module 120, in connection with training and compressing the untrained DNN 112, includes a partition module 126, a redundancy identifier module 128, and an output module 130. Operations of the modules 126-130 will be described in detail below; however, in summary, the partition module 126 identifies a class of minimal removal structures (ZIGs) in the untrained DNN 112. As noted above, a ZIG is a minimal structure that can be removed from the untrained DNN 112, where the DNN remains valid (e.g., generates valid output) when variable values corresponding to the ZIGs are set to zero. The redundancy identifier module 128 trains the untrained DNN 112 based upon the training data 114 and identifies redundant ZIGs during training. The output module 130 removes ZIGs from the untrained DNN 112 based upon the identities of the ZIGs identified by the redundancy identifier module 128. Hence, the untrained DNN 112 includes a structure, and the trained and compressed DNN 122 output by the TAC module 120 fails to include such structure. The structure can include a filter, a bias vector, a scalor, or other suitable structure found in DNNs and associated with operators, such as an activation operator, a convolution operator, a batch normalization operator, an average pooling operator, an addition operator, a concatenation operator, or the like.

The trained and compressed DNN 122 consumes a smaller amount of computer-readable storage than would be consumed by a corresponding DNN trained in a conventional manner (e.g., the untrained DNN 112 after being trained using conventional technologies). In an example, the trained and compressed DNN 122 consumes between 20% and 50% less computer-readable storage when compared to the DNN trained conventionally (and not compressed). In another example, the trained and compressed DNN 122 consumes between 30% and 40% less computer-readable storage when compared to the DNN trained conventionally (and not compressed). Further, the trained and compressed DNN 122 can generate outputs that are similar to those that would be generated by the DNN trained using conventional approaches (and not compressed). Hence, compression of the DNN utilizing the technologies described herein need not significantly impact accuracy of inferences generated by the trained and compressed DNN 122.

The trained and compressed DNN 122 can be deployed on computing devices where computing resources are somewhat constrained. For example, a mobile computing device can store and execute the trained and compressed DNN 122, where the mobile computing device may be a mobile telephone, a tablet computing device, an e-reader, and so forth. In another example, the trained and compressed DNN 122 is executed using fewer processing cores when compared to processing cores needed to execute the DNN when trained conventionally (and uncompressed); this is due at least partially to the reduction in FLOPs associated with the trained and compressed DNN 122 when compared to the uncompressed DNN.

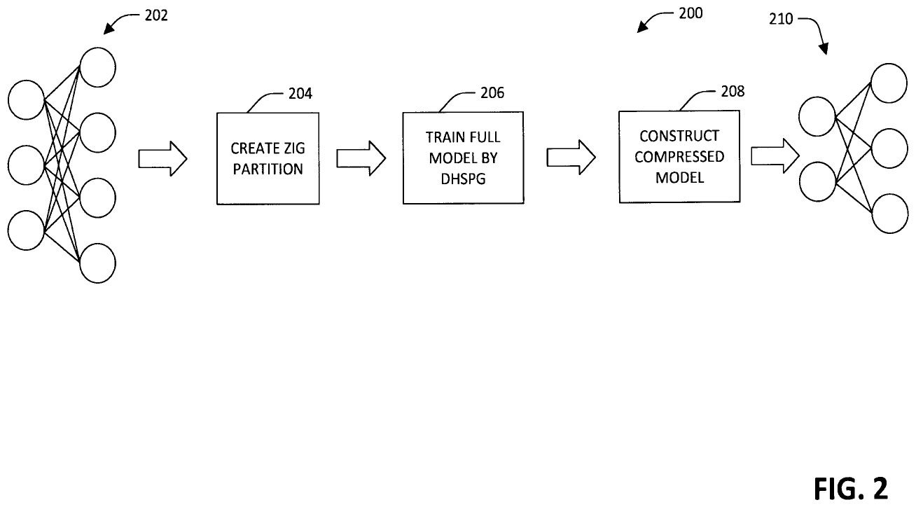

With reference now to FIG. 2, a schematic 200 that illustrates operation of the TAC module 120 is presented. An untrained DNN 202 is acquired, and at 204 minimal removal structures (ZIGs) are identified and ZIG partitions are formed (as described in detail below). At 206, the DNN 202 is trained through use of the DHSPG algorithm, which is also described in detail below. At 208, a compressed DNN is constructed based upon the training of the full model performed at 206. The compressed DNN 208 includes fewer structures, for example, when compared to the uncompressed DNN 202.

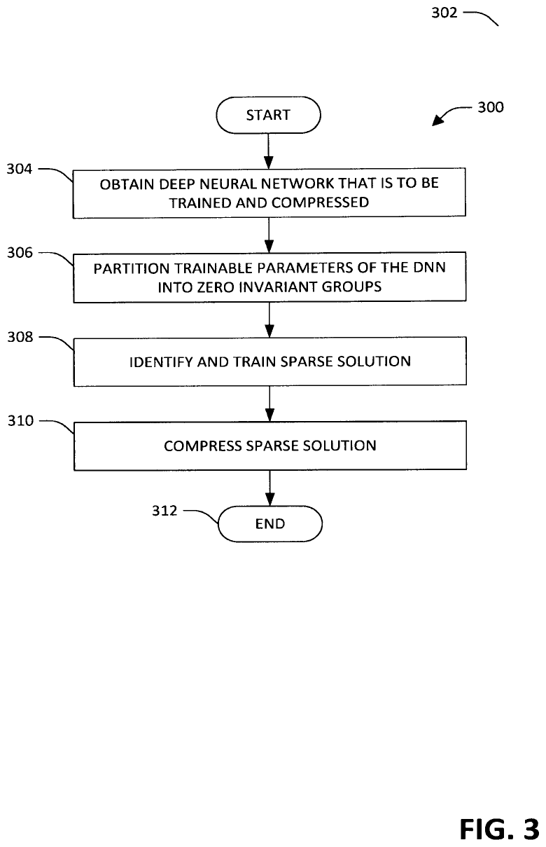

FIGS. 3, 5, 10, and 12 illustrate methodologies relating to training and compressing a DNN. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring specifically to FIG. 3, a flow diagram illustrating a methodology 300 performed by the TAC module 120 is presented. The methodology 300 starts at 302, and at 304 a DNN [symbol] that is to be trained and compressed (e.g., the untrained DNN 122) is received. The TAC module 120 identifies minimal removal structures in [symbol] , and at 306 partitions trainable variables in such minimal removal structures into ZIGs ( [symbol] ). At 308, [symbol] is trained by way of the DHSPG algorithm referenced above. With more specificity, a structured optimization problem is formulated, and the ZIGs identified at 306 are provided as input to the DHSPG algorithm, which yields a sparse solution x_{DHSPG}⁺ to such problem. At 310, a compressed model [symbol] * is constructed by removing redundant structures that correspond to the ZIGs being zero. [symbol] * is associated with acceleration in inference in terms of both time and space complexities, and returns outputs that are identical to those output by the full model [symbol] when parameterized as x_{DHSPG}⁺ due to the properties of ZIGs, thereby avoiding further fine tuning of [symbol] *. An outline of the operations performed by the TAC module 120 is set forth below as Algorithm 1. The methodology 300 completes at 312.

ALGORITHM 1

| | |
|---|---|
| 1. | Input. An arbitrary full model [symbol] that is to be trained |
| | and compressed (no pretraining required). |
| 2. | Automated ZIG Partition. Partition the trainable parameters |
| | of [symbol] into [symbol] . |
| 3. | Train [symbol] by DHSPG. Seek a group-sparse solution x*_{DHSPG} with |
| | satisfactory performance. |
| 4. | Output. Compressed model [symbol] *. |

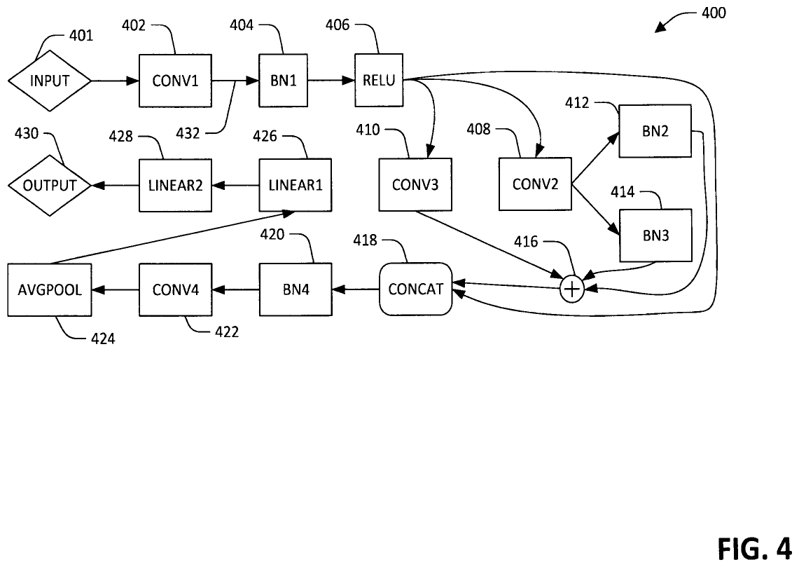

Referring now to FIG. 4, a trace graph (ε, [symbol] ) 400 of an example DNN (e.g., the untrained DNN 112) is depicted. The trace graph 400 includes numerous vertices [symbol] and edges ε, where vertices represent operators in the untrained DNN 112 and edges represent connections between such operators. The trace graph 400 includes a first vertex 402 that represents a first convolution operator, a second vertex 404 that represents a first batch normalization operator, a third vertex 406 that represents an activation operator, a fourth vertex 408 that represents a second convolution operator, a fifth vertex 410 that represents a third convolution operator, a sixth vertex 412 that represents a second batch normalization operator, a seventh vertex 414 that represents a third batch normalization operator, an eighth vertex 416 that represents an addition operator, a ninth vertex 420 that represents a concatenation operator, a tenth vertex 422 that represents a fourth batch normalization operator, an eleventh vertex 424 that represents a fourth convolution operator, a twelfth vertex 426 that represents an average pooling operator, a thirteenth vertex 428 that represents a first linear operator, and a fourteenth vertex 430 that represents a second linear operator. The trace graph 400 also includes a node 401 that represents an input and a node 430 that represents an output.

As noted above, the trace graph 400 further includes edges that represent connections between the operators represented by the vertices of the trace graph 400. For example, the trace graph 400 includes an edge 432 that couples the first vertex 402 and the second vertex 404, where the edge indicates that the first convolution operator generates output that is received as input by the first batch normalization operator.

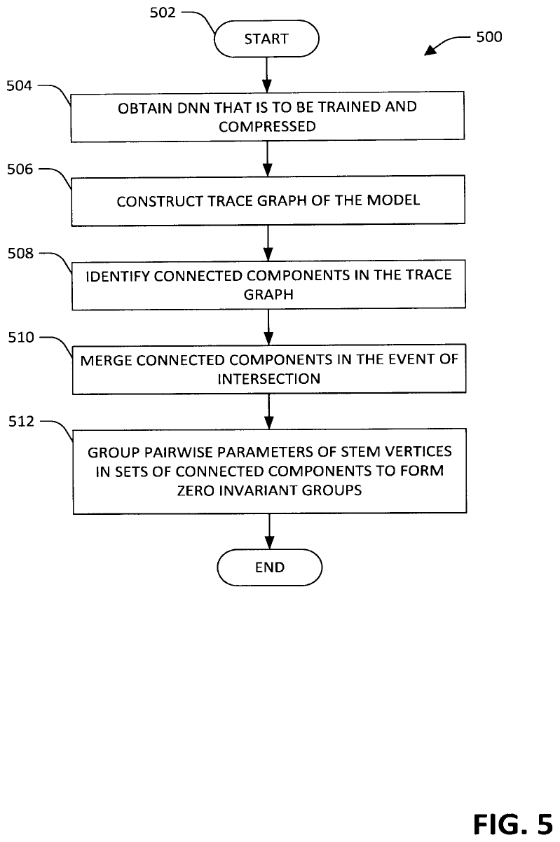

Referring to FIG. 5, a methodology 500 that depicts operation of the partition module 126 in connection with creating ZIG partitions is presented. In the description of the methodology 500, vertices are described as performing actions; it is understood that operators represented by the vertices are performing the described actions; vertices are described as performing such actions for ease of description. The methodology starts at 502, and at 504 a DNN [symbol] that is to be trained and compressed is obtained. At 506, a trace graph (ε, [symbol] ) of the model [symbol] is constructed. The trace graph includes vertices [symbol] and edges ε, where each vertex in [symbol] represents a specific operator, and edges in ε describe how the operators connect in [symbol] . The partition module 126 assigns a category (from amongst several predefined categories) to each vertex in the trace graph based upon features of the operators represented by the vertices and connections between such operators. For instance, a vertex in the vertices is assigned a category of “stem,” “joint,” “accessory,” or “unknown.”

A stem vertex represents an operator that is equipped with a trainable parameter and has the ability to transform a tensor received by the operator into another shape. Thus, a stem vertex represents a convolution operator, a linear operator, etc. A joint vertex represents an operator that aggregates multiple input tensors into a single output. Therefore, a joint vertex represents an addition operator, a multiplication operator, a concatenation operator, or the like. An accessory vertex represents an operator that is equipped with a trainable parameter and receives a tensor as input and generates a single value as output. Accordingly, an accessory vertex represents a batch normalization operator, an activation operator, etc. An unknown vertex represents an operator that has uncertain operations.

It has been observed that stem vertices represent operators that include most trainable parameters of DNNs, while joint vertices represent operators that establish connections across different operators and are therefore associated with hierarchy and intricacy of a DNN. To maintain validity of operators represented by joint vertices, minimal removal structures are carefully constructed. Moreover, joint vertices are classified as being “input shape dependent” (SD) if such vertices represent operators that require inputs in the same shape, such as an addition operator. Otherwise, a joint vertex is classified as being shape independent (SID), where an example of a SD vertex is the ninth vertex 420 in the trace graph 400, which represents the concatenation operator.

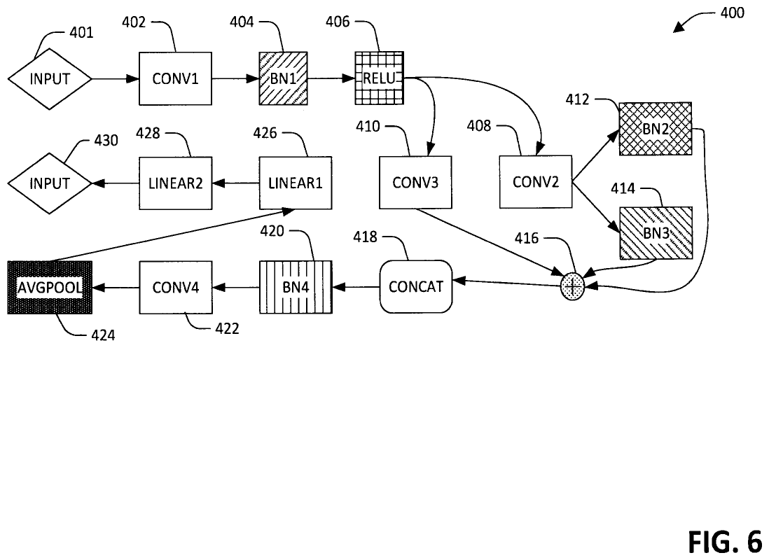

Referring briefly to FIG. 6, the trace graph 400 is depicted with some of the vertices therein shaded to illustrate that such vertices are assigned categories of “accessory” and “SD joint.” Specifically, the second vertex 404, the sixth vertex 412, the seventh vertex 414, the tenth vertex 420, and the twelfth vertex 424 (which represent batch normalization and average pooling operators) are categorized as accessory vertices, while the eighth vertex 416 (that represents the addition operator) is categorized as a SD joint vertex.

Returning to FIG. 5, upon the trace graph of the DNN [symbol] being constructed at 506 and categories assigned to vertices therein, at 508 connected components in the trace graph are identified. Identifying the connected components refers to identifying dependencies across vertices of the trace graph in order to ascertain minimal removal structures of the DNN. To identify connected components, the partition module 126 connects adjacent accessory. SD joint, and unknown vertices together, thus forming a set of connected components [symbol] . Connection of these vertices establishes skeletons for identifying operators that depend on each other when considering removing hidden structures. The underlying intuitions for performing this step are: 1) adjacent accessory vertices operate and are subject to the same ancestral stem vertices, if any; 2) SD joint vertices force their ancestral stem vertices to depend upon each other to yield tensors in the same shapes; and 3) unknown vertices introduce uncertainty, and thus finding potential affected vertices is necessary.

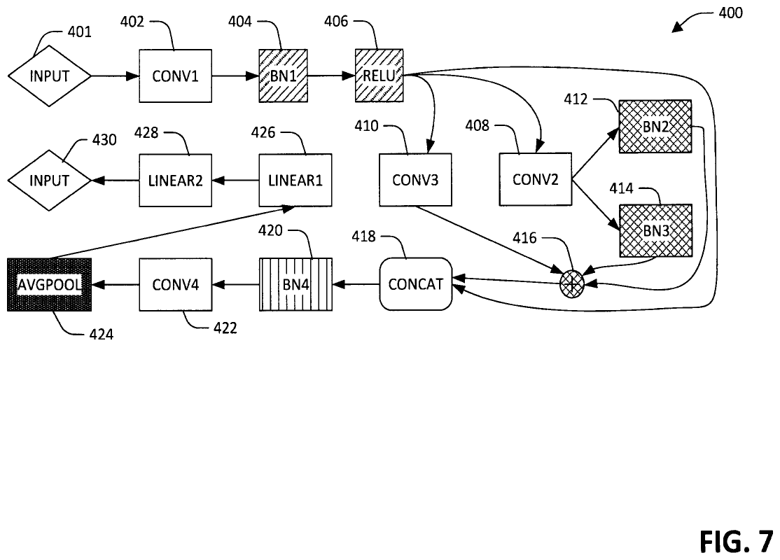

With reference to FIG. 7, vertices in the trace graph 400 are shaded to represent connected components [symbol] in the DNN [symbol] . For instance, the second vertex 404 (representing the first batch normalization operator) and the third vertex 406 (representing the activation operator) are identified as being a first set of connected components due to the vertices 404 and 406 being accessory vertices and being adjacent in the trace graph 400. Similarly, the sixth vertex 412, the seventh vertex 414, and the eighth vertex 416 are identified as being a second set of connected components, as the eighth vertex 416 is a SD joint vertex and the seventh and eighth vertices are accessory vertices (and each of the sixth vertex 412 and the seventh vertex 414 are adjacent to the eighth vertex 416 in the trace graph 400). The tenth vertex 420 is identified as being a third set of connected components (due to the tenth vertex 420 being categorized as an accessory vertex), and the twelfth vertex 424 is identified as being a fourth set of connected components (due to the twelfth vertex 424 being categorized as an accessory vertex). Therefore, in this example, four sets of connected components are identified.

Returning again to FIG. 5, upon the connected components in the trace graph being identified, at 510 each set of connected components is grown to include all incoming vertices that are either a stem vertex or a joint vertex; intersecting sets of connected components are then merged. It is noted that a stem vertex that is newly added to a set of connected components is affiliated by at least one accessory vertex.

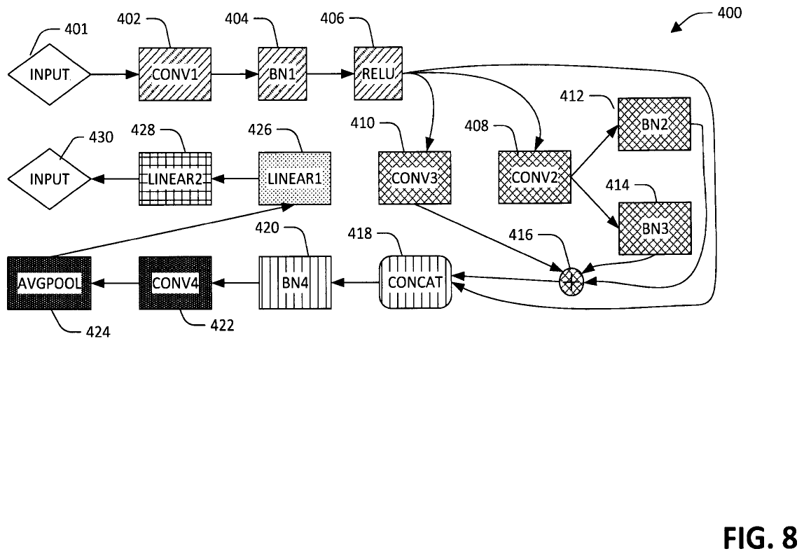

With reference to FIG. 8, the trace graph 400 is again presented, with vertices therein shaded to identify the results of growing and merging the initially identified sets of connected components. Specifically, as illustrated in FIG. 8, the first set of connected components is grown to include the first vertex 402. The second set of connected components is grown to include the fourth vertex 408 and the fifth vertex 408, which are stem vertices that provide input to accessory and SD vertices (the vertices 412-416). The third set of connected components is grown to include the ninth vertex 418, and the fourth set of connected components is grown to include the eleventh vertex 422. These sets of connected components are employed in connection with identifying ZIGs in the DNN [symbol] .

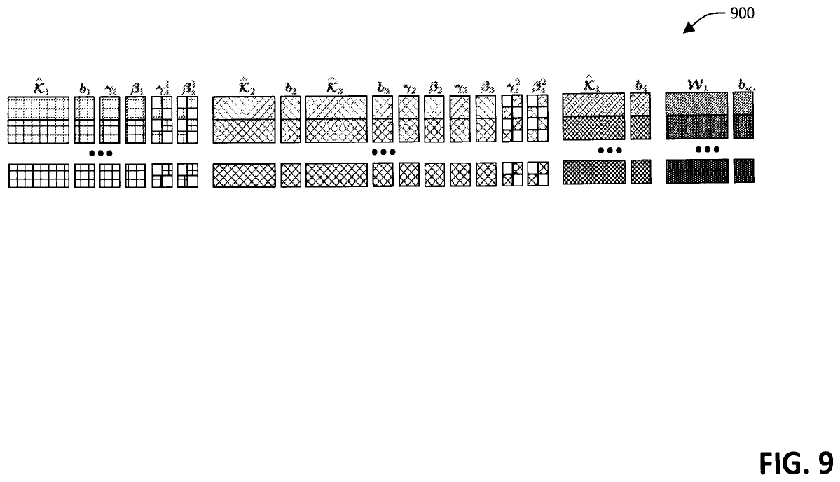

With reference again to FIG. 5, at 512 the partition module 126 forms ZIGs based upon the sets of connected components formed after the growing and merging referenced above. Pairwise trainable parameters of all operators represented by stem vertices in a set of connected components are first grouped together, as graphically depicted in the schematic 900 of FIG. 9. Blocks shaded with the same shading pattern represent one group of pairwise trainable parameters. Further, accessory vertices insert their trainable parameters, if applicable, into the groups of their dependent stem vertices. Some accessory vertices, such as the tenth vertex 420 that represents the fourth batch normalization operator, may depend on multiple groups because of the SID joint vertex (the ninth vertex 418). Thus, trainable parameters γ₄ and β₄ are partitioned and separately added into corresponding groups, e.g., γ₄¹, β₄¹ and γ₄², β₄², where γ refers to a weighting vector of a batch normalization operator and β refers a bias vector of a batch normalization operator. In addition, connected components that are adjacent to the output of the DNN [symbol] are excluded from forming ZIGs, since the output shape should be fixed (such as the output of the fourteenth vertex 428 corresponding to the second linear operator). Further, the partition module 126 can optionally exclude sets of connected components that possess unknown vertices to avoid uncertainty, which guarantees generality of the framework such that the framework is applicable to DNNs that include customized operators. An example implementation of the methodology 500 is presented in Algorithm 2, shown below.

ALGORITHM 1

| | |
|---|---|
| 1. | Input: A DNN [symbol] to be trained and compressed. |
| 2. | Construct the trace graph (ε, [symbol] ) of [symbol] . |
| 3. | Find connected components [symbol] over all accessory, shape-dependent |
| | joint and unknown vertices. |
| 4. | Grow [symbol] until incoming vertices are either stem or SID joint vertices. |
| 5. | Merge connected components in [symbol] if there is any intersection. |
| 6. | Group pairwise parameters of stem vertices in the same connected |
| | component associated with parameters from affiliated accessory |
| | vertices if any as one ZIG into [symbol] . |
| 7. | Return the ZIGs [symbol] . |

The methodology 500 complete at 514.

In an example, the methodology 500 can be implemented as a series of customized graph algorithms that are composed together. In depth, each individual sub-algorithm is achieved by depth first search recursively traversing the trace graph of a DNN and conducting step-specific operations, which has time complexity of [symbol] (| [symbol] |+|ε|) and space complexity of [symbol] (| [symbol] |) in the worst case. The former is computed by discovering all neighbors of each vertex by traversing the adjacency list once in linear time. The latter is because the trace graph of the DNN is acyclic, and thus the memory cache consumption is up to the length of possible longest path for an acyclic graph as | [symbol] |. Hence, the partition module 126 can identify ZIGs in a DNN in linear time.

Referring again to FIG. 9, this figure depicts the schematic 900 that illustrates ZIG partitioning performed by the partition module 126. [symbol] ᵢ and bᵢ are the flatten filter matrix and bias vector of a vertex that represents convolutional operator i, where the jth row of [symbol] ᵢ represents the jth 3D filter. γ₁ and β₁ are the weighting and bias vectors of a vertex that represents batch normalization operator i. [symbol] ᵢ and b_{w}_{ᵢ} are the weighting matrix and bias vector for of a vertex that represents linear operator i. The ground truth ZIGs [symbol] corresponding to the trace graph 400 are depicted in the schematic 900. Since the output tensors of the convolution operators represented by the forth and fifth vertices 408 and 410 are added together, both layers associated with the subsequent batch normalization operators represented by the sixth and seventh vertices 412 and 414, the same number of filters from [symbol] ₂ and [symbol] ₃ and scalars must be removed from b₂, b₃, γ₂, γ₃, β₂, and β₃ to keep the addition valid. Since the batch normalization operator represented by the tenth vertex 420 normalizes concatenated outputs along the channel of CONV1-BN1-RELU and CONV3+CONV4-BN2|BN3, the corresponding scalars in γ₄, β₄ need to be removed simultaneously.

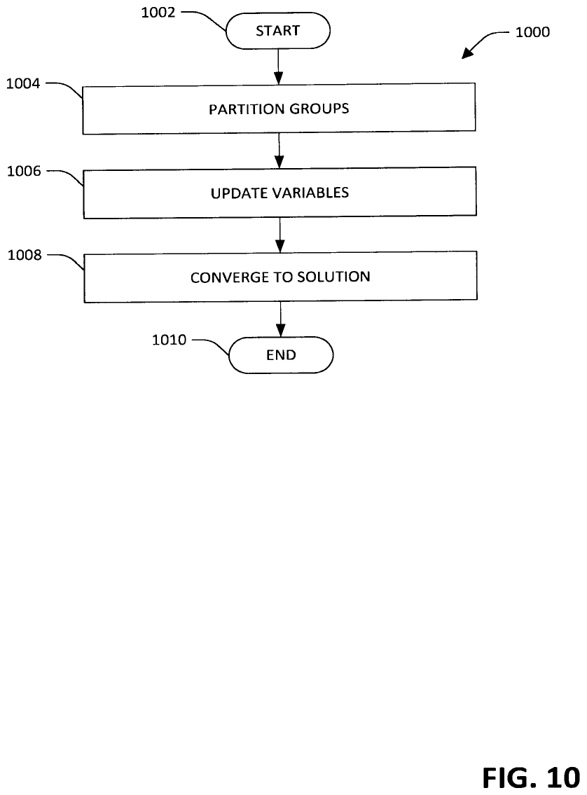

With reference now to FIG. 10, a flow diagram 1000 that depicts operations performed by the redundancy identifier module 128 in connection with identifying redundant ZIGs in [symbol] output by the partition module 126 is presented. With more specificity, given the ZIGs [symbol] constructed by the partition module 126 by way of the methodology 500, the redundancy identifier module 128 jointly identifies which groups are redundant for removal and trains the remaining groups to achieve acceptable performance. In connection with performing such operations, a structured sparsity optimization problem is formulated, and the redundancy identifier module 128 solves such problem by way of a DHSPG algorithm. The DHSPG algorithm is advantageous over conventional algorithms, as DHSPG constitutes a dual half space direction with automatically selected regularization coefficients to more reliably control the sparsity exploration; the DHSPG algorithm further enlarges the search space by partitioning ZIGs into separate sets to avoid trapping around the origin for better generalization.

A structured sparsity inducing optimization problem was selected to seek a group sparse solution with high performance, where the zero groups (where parameter values are set to zero) refer to redundant structures, and non-zero groups exhibit prediction power to maintain adequate performance when compared to the full model. The optimization problem with a group sparsity constraint in the form of ZIGs [symbol] can be formulated as:

$$\begin{matrix}minimize \\ x ∈ {R}^{n}\end{matrix} f ( x ) , s . t . Card \{ g ∈ \vert \vert x {\vert}_{g} = 0 \} = K , \qquad ( 1 )$$

where K is the target group sparsity level. Larger K indicates higher group sparsity in the solution and typically results in more aggressive FLOPs and parameter quantity reductions.

The methodology 1000 starts at 1002, and at 1004 groups in [symbol] are partitioned into two subsets: a first subset where magnitudes of variables are penalized ( [symbol] ₚ), and a second subset where penalization of variable magnitudes is not forced ( [symbol] ₙₚ). Different criteria can be applied to construct the above partition based on salient scores, such as cosine similarity cos (θ_{g}) between the projection direction −[x]_{g} and the negative gradient or its estimation −[∇f(x)]_{g}. Higher cosine similarity over g∈ [symbol] indicates that projecting the group of variables in g onto zeros is more likely to make progress to the optimality of f (considering the descent direction from the perspective of optimization). The magnitude over [x]_{g} then needs to be penalized. Thus, the redundancy identifier module 128 can compute [symbol] ₚ by picking up the ZIGs with top-K highest salient scores and select [symbol] ₙₚ as the remaining ZIGs in G:

$${P}_{} = ( Top - K ) salience - score ( g ) and {np}_{} = \{ 1 , 2 , … , n \} / {P}_{} \qquad ( 2 )$$

To compute more reliable scores, the redundancy identifier module 128 proceeds with the partition after performing T_{w} warmup steps by way of stochastic gradient descent.

At 1006, variables in [symbol] are updated. More specifically, for the variables in [symbol] ₙₚ, where magnitudes are not penalized, the redundancy identifier module 128 performs stochastic gradient descent or a variant thereof, such as [symbol] ← [symbol] − [symbol] . For groups of variables in [symbol] ₚ, to penalize magnitude, the redundancy identifier module 128 seeks to find redundant groups as zero; but instead of directly projecting them onto zero, the following relaxed non-constrained subproblem is constrained to gradually reduce the magnitudes without deteriorating the objective and project groups onto zeros if the projection serves as a descent direction during the training process:

$${minimize}_{{[ x ]}_{{𝒢}_{p}}} ψ ( {[ x ]}_{{𝒢}_{p}} ) := f ( {[ x ]}_{{𝒢}_{p}} ) + {\sum }_{g ∈ {𝒢}_{p}} {λ}_{g} {‖ {[ x ]}_{g} ‖}_{2} , \qquad ( 3 )$$

where λ_{g} is a group-specific regularization coefficient and needs to be chosen to guarantee the decrease of both the variable magnitude for g as well as the objective f.

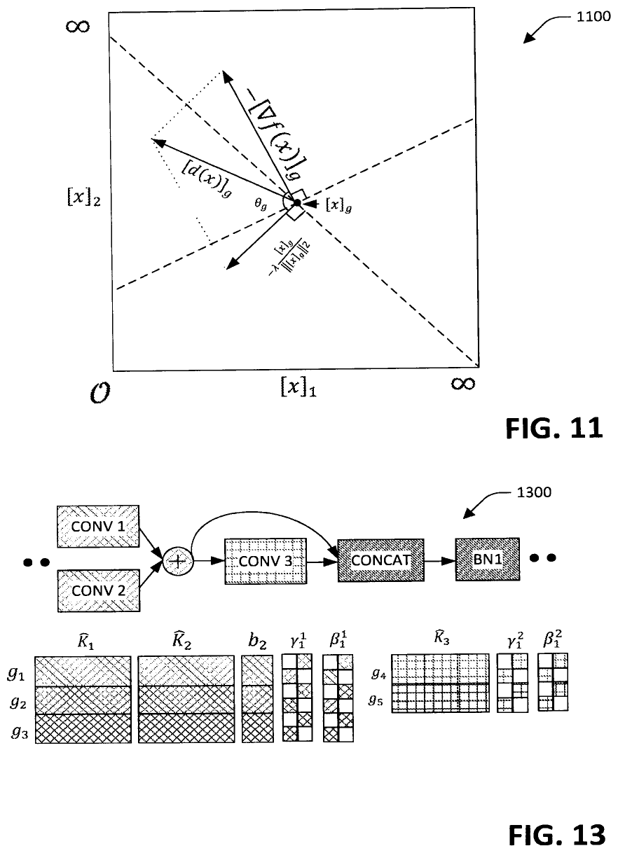

In particular, the redundancy identifier module 128 computes a negative subgradient of ψ as the search direction [symbol] :=− [symbol] − [symbol] /max{∥[x]_{g}∥₂,τ}, with τ as a safeguard constant. To ensure [symbol] as a decent direction for both f and ∥x∥₂, [d(x)]_{g} needs to fall into the intersection between the dual half-spaces with normal directions as −[∇f]_{g} and −[x]_{g} for any g∈ [symbol] ₚ, as depicted in the plot 1100 of FIG. 11 (e.g., the plot 1100 illustrates search direction in DHSPG). In other words, [symbol] [− [symbol] and [symbol] are greater than 0. It further indicates that Ag locates in the interval

$$( {λ}_{min , g} , {λ}_{max , g} ) := ( - cos ( {θ}_{g} ) {‖ ∇ {f ( x )}_{g} ‖}_{2} , - \frac{{‖ {[ ∇ f ( x ) ]}_{g} ‖}_{2}}{cos ( {θ}_{g} )} )$$

if cos (θ_{g})<0, otherwise can be an arbitrary positive constant. Such λ_{g} brings the decrease of both the objective and the variable magnitude. The redundancy identifier module 128 can then compute a trial iterate [symbol] ← [symbol] via the subgradient descent of ψ. The trial iterate is fed into a Half-Space projector, which yields group sparsity without hurting the objective.

At 1008, the redundancy module 128 converges to the solution of x_{DHSPG}⁺ in the manner of both theory and practice. In fact, the theoretical convergence relies on the construction of dual half-space net mechanisms, which yield sufficient decrease for both objective f and variable magnitude. Hence, the redundancy identifier module 128 effectively computes a solution with desired group sparsity. In addition, the redundancy identifier module 128 consumes the same time complexity [symbol] (n), since all operations can be finished within linear time.

Algorithm 3 depicts an example implementation of the methodology 1000.

ALGORITHM 3

| | |
|---|---|
| 1. | Input: initial variable x₀, ϵ [symbol] ⁿ, initial learning rate α₀, warm-up steps |
| | T_{w}, half-space project steps Tₕ, target group sparsity K, and ZIGs [symbol] . |
| 2. | Warm up T_{w} steps by way of stochastic gradient descent. |
| 3. | Construct [symbol] ₚ and [symbol] ₙₚ given [symbol] and K (Eq. 2) |
| 4. | for t = T_{w} + 1, T₂ + 2, ... , do |
| 5. | Compute gradient estimate ∇ƒ (xₜ) or a variant thereof. |
| 6. | Update [symbol] as [symbol] . |
| 7. | Select proper λ_{g} for g ϵ [symbol] ₚ. |
| 8. | Compute [symbol] by way of subgradient descent of w. |
| 9. | if t ≥ Tₕ, then |
| 10. | Perform Half-Space projection over [symbol] . |
| 11. | Update [symbol] ← [symbol] . |
| 12. | Update αₜ₊₁ |
| 13. | Return final iterate x*_{DHSPG}. |

The methodology 500 completes at 1010.

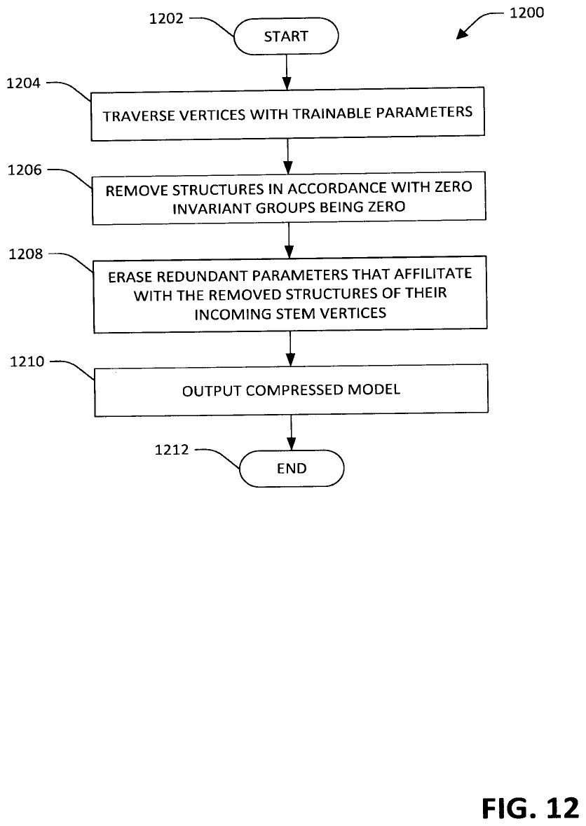

With reference now to FIG. 12, a methodology 1200 performed by the output module 130 is illustrated, where the methodology 1200 is directed towards compressing the model trained by the partition module 128 (e.g., by way of the methodology 1000). The methodology 1200 starts at 1202, and at 1204 all vertices with trainable parameters in [symbol] are traversed. At 1206, structures are removed from the solution x_{DHSPG}⁺ in accordance with ZIGs being zero. Referring briefly to FIG. 13, a schematic 1300 is presented that illustrates structures that are removed in accordance with ZIGs being zero; specifically, the dotted rows of [symbol] ₁, [symbol] ₂, [symbol] ₃ and scalars of b₂, γ₁, γ₁. At 1208, the output module 130 erases the redundant parameters that affiliate with the removed structures of their incoming stem vertices to keep the operations valid, e.g., the second and third channels in g₅ are removed even though g₅ is not zero. At 1210, the compressed module is output and at 1212 the methodology 1200 completes. The methodology 1200 can be performed in linear time by performing two passes of depth first search and manipulating parameters to produce a compact DNN [symbol] *. Based on the property of ZIGs, [symbol] * returns the same inference outputs as the fully trained and uncompressed model [symbol] parameterized as x_{DHSPG}⁺; hence, no further fine-tuning of [symbol] * is necessary.

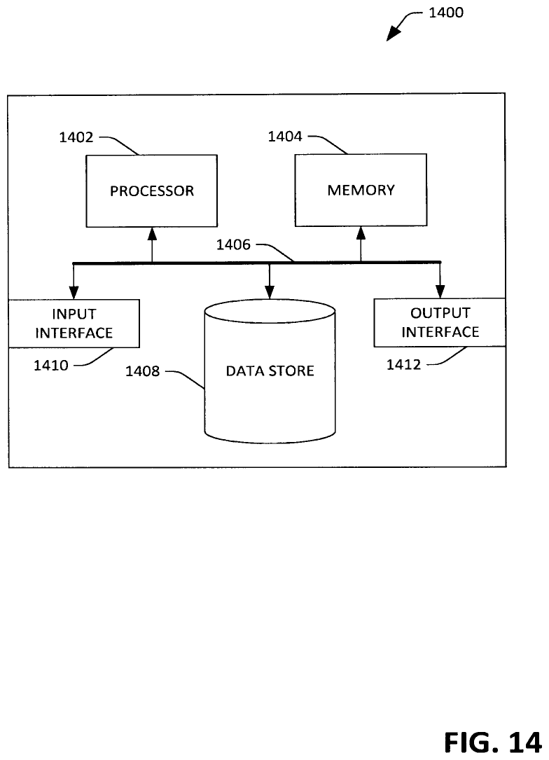

Referring now to FIG. 14, a high-level illustration of an exemplary computing device 1400 that can be used in accordance with the systems and methodologies disclosed herein is illustrated. For instance, the computing device 1400 may be used in a system that trains and compresses a DNN without the need for fine-tuning. By way of another example, the computing device 1400 can be used in a system that generates inferences through use of a trained and compressed DNN. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store a trace graph, ZIG identities, hyperparameters, etc.

The computing device 1400 additionally includes a data store 1408 that is accessible by the processor 1402 by way of the system bus 1406. The data store 1408 may include executable instructions, a trace graph of a DNN, etc. The computing device 1400 also includes an input interface 1410 that allows external devices to communicate with the computing device 1400. For instance, the input interface 1410 may be used to receive instructions from an external computer device, from a user, etc. The computing device 1400 also includes an output interface 1412 that interfaces the computing device 1400 with one or more external devices. For example, the computing device 1400 may display text, images, etc. by way of the output interface 1412.

It is contemplated that the external devices that communicate with the computing device 1400 via the input interface 1410 and the output interface 1412 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1400 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1400 may be a distributed system. Thus, for instance, several devices may be in communication by way of a network connection and may collectively perform tasks described as being performed by the computing device 1400.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
obtaining an untrained computer-implemented model that is to be trained and compressed, wherein the untrained computer-implemented model includes an operator that comprises a structure;
obtaining training data that is to be employed to train the untrained computer-implemented model;
receiving a request from a user to train and compress the untrained computer-implemented model; and
based upon the request and the training data, and without further input from the user, training and compressing the untrained computer-implemented model to generate a trained and compressed computer-implemented model, wherein the trained and compressed computer-implemented model fails to include the structure.

2. The computing system of claim 1, wherein the operator is at least one of an activation function, a convolution function, a batch normalization function, or an average pooling function.

3. The computing system of claim 1, wherein training and compressing the computer-implemented model comprises:
identifying the structure as a removable structure, the removable structure being removable from the computer-implemented model such that the computer-implemented model generates valid output when the removable structure is removed from the computer-implemented model.

4. The computing system of claim 3, wherein identifying the structure as the removable structure comprises:
constructing a trace graph of the computer-implemented model, where the trace graph comprises:
vertices that represent operators in the computer-implemented model, where the vertices comprise a first vertex that represents the operator and a second vertex that represents a second operator; and
edges that represent connections between the operators, where the edges comprise an edge between the operator and the second operator;
assigning a category from amongst several potential categories to the first vertex, where the category is assigned to the first vertex based upon a parameter of the operator, and further wherein the structure is identified as the removable structure based upon the category assigned to the first vertex.

5. The computing system of claim 4, wherein identifying the structure as the removable structure comprises identifying the structure as being the removable structure based upon the category assigned to the first vertex, where the removable structure belongs to a class of minimal structures that are able to be removed from the computer-implemented model without impacting output of the computer-implemented model when parameters of the minimal structures are zero.

6. The computing system of claim 5, where training and compressing the computer-implemented model to generate the trained and compressed computer-implemented model further comprises:
identifying the removable structure as being redundant with another removable structure in the computer-implemented model.

7. The computing system of claim 6, wherein training and compressing the untrained model to generate the trained and compressed computer-implemented model further comprises removing the removable structure from the computer-implemented model based upon the removable structure being identified as being redundant with the another removable structure.

8. A method performed by a computing system, the method comprising:
receiving an untrained computer-implemented deep neural network (DNN), where the untrained computer-implemented DNN includes a structure;
obtaining training data for training the untrained computer-implemented DNN;
constructing a trace graph that is representative of operators included in the untrained computer-implemented DNN and connections between the operators; and
training and compressing the untrained computer-implemented DNN to generate a trained and compressed DNN, where the untrained computer-implemented DNN is trained and compressed based upon the trace graph and the training data, and further where the trained and compressed DNN does not include the structure that is included in the untrained computer-implemented DNN.

9. The method of claim 8, further comprising using the DNN to generate output without fine-tuning the DNN.

10. The method of claim 8, wherein the structure corresponds to at least one of an activation operator, a convolution operator, a batch normalization operator, or an average pooling operator.

11. The method of claim 8, wherein the graph comprises:
vertices that represent operators in the computer-implemented model, where the vertices comprise a first vertex that represents a first operator and a second vertex that represents a second operator, and further where the first operator comprises the structure; and
edges that represent connections between the operators, where the edges comprise an edge between the first operator and the second operator;
wherein training and compressing the untrained computer-implemented DNN to generate a trained and compressed DNN comprises assigning a category from amongst several potential categories to the first vertex, where the category is assigned to the first vertex based upon a parameter of the first operator, and further where the structure is identified as being removable from the computer-implemented DNN based upon the category assigned to the first vertex.

12. The method of claim 11, further comprising identifying the structure as removable from the computer-implemented DNN based upon the category assigned to the first vertex, where the structure belongs to a class of minimal structures that are removable from the computer-implemented DNN without impacting output of the computer-implemented DNN when parameters of the minimal structures are zero.

13. The method of claim 12, where training and compressing the untrained computer-implemented DNN to generate the trained and compressed computer-implemented model further comprises:
subsequent to identifying the structure as being removable from the computer-implemented DNN, identifying the structure as being redundant with another structure in the computer-implemented DNN.

14. The method of claim 13, wherein training and compressing the untrained computer-implemented DNN to generate the trained and compressed computer-implemented DNN further comprises removing the structure from the computer-implemented DNN based upon the structure being identified as being redundant with the another structure in the computer-implemented DNN.

15. The method of claim 8, where the DNN is a convolutional neural network.

16. The method of claim 8, wherein the untrained computer-implemented DNN, when trained, consumes a first amount of computer-readable memory, the trained and compressed computer-implemented DNN consumes a second amount of computer-readable memory, and further where the second amount of computer-readable memory is less than the first amount of computer-readable memory.

17. The method of claim 16, where the second amount of computer-readable memory is between 20% and 50% less than the first amount of computer-readable memory.

18. A computer-readable storage medium comprising instructions that, when executed by a processor, cause the processor to perform acts comprising:
obtaining an untrained computer-implemented model that is to be trained and compressed, wherein the untrained computer-implemented model includes an operator that comprises a structure;
obtaining training data that is to be employed to train the untrained computer-implemented model;
receiving a request from a user to train and compress the untrained computer-implemented model; and
based upon the request and the training data, and without further input from the user, training and compressing the untrained computer-implemented model to generate a trained and compressed computer-implemented model, wherein the trained and compressed computer-implemented model fails to include the operator.

19. The computer-readable storage medium of claim 18, wherein the operator is at least one of an activation operator, a convolution operator, a batch normalization operator, or an average pooling operator.

20. The computer-readable storage medium of claim 18, wherein training and compressing the computer-implemented model comprises:
identifying the structure as a removable structure, the removable structure being removable from the computer-implemented model such that the computer-implemented model generates valid output when the removable structure is removed from the computer-implemented model.
